(19) United States
(12) Patent Application Publication
(10) Pub. No.: US 2019/0094061 A1
(43) Pub. Date: Mar. 28, 2019

(54) SEALED EXTERNAL TANK GAUGE ASSEMBLY

(71) Applicants: MICHAEL PARKER, TUSCOLA, TX (US); JUSTIN STATON, ABILENE, TX (US)

(72) Inventors: MICHAEL PARKER, TUSCOLA, TX (US); JUSTIN STATON, ABILENE, TX (US)

(21) Appl. No.: 15/714,837

(22) Filed: Sep. 25, 2017

(51) Int. Cl. G01F 23/42

(52) U.S. Cl. CPC G01F 23/42

(57) ABSTRACT

An assembly and method for the measuring of fluids in a tank. The assembly uses a fluid measuring system to measure and indicate the fluid levels inside the tank. The assembly creates a sealed unit that couples to the tank and external gauge so as to stop the venting of gas to the atmosphere. The assembly may include the tank and external gauge in selected embodiments. The assembly can function without the use of electronic measuring and reporting devices.

### BACKGROUND

### 1. Field of the Invention

The present invention is related to the storage of fluids in a tank, specifically related to providing an external measurement of the fluids levels within a storage tank.

### 2. Description of Related Art

The desire to know how much liquid is in a container or tank has been held ever since the first container was filled. This desire has increased as the size of containers and tanks have increased in size and volume. Tanks have increased in size to the point that a user cannot simply open up the tank to determine the fluid level inside.

A simple float, having a specific gravity between the liquid and the vapor in the tank will accurately follow the rise and fall of the liquid while being reliable, cheap and simple. Early float systems used mechanical components such as cables, tapes, pulleys and gears to communicate the fluid level inside the tank to an external gauge. The external gauge indicates a numerical value of the amount of fluid in a tank based on specified units of measurement (e.g. gallons, cubic feet, cubic meters, etc.).

Currently, the cables and tapes from the float exit the tank through an open hole in the tank. This hole allows the vapors within the tank to continuously escape, or outgas, into the environment. The continuous out-gassing is problematic for the environment and, in some states, has resulted in additional permitting and costs for users. As a solution, users have begun to use more sophisticated, and expensive, methods to measure fluid levels in a tank. these methods include: hydrostatic measurement devices, load cells, magnetic level gauges, capacitance transmitters, and magnetostrictive level transmitters to name some. While these new methods can be as reliable as the float method, the new methods are more complicated and are more expensive to fix when things break.

Although strides have been made in the measuring of fluids in a tank, considerable shortcomings remain. It is desirable for users to use an accurate, cheap, and simple method of measuring the fluid levels in the tank while being conscious of environmental issues.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a back, perspective view of a sealed external tank gauge assembly according to an embodiment of the present application.

FIG. 2 is a front section view of the sealed external tank gauge assembly of FIG. 1 and an associated cutout view of a tank.

FIG. 3 is a front section view of the sealed external tank gauge assembly of FIG. 1.

FIG. 4 is an exploded perspective view of a housing unit of the sealed external tank gauge assembly of FIG. 1.

FIG. 5 is an exploded front view of the housing unit of the sealed external tank gauge assembly of FIG. 1.

FIG. 6 is an exploded view of a first arm of the sealed external tank gauge assembly of FIG. 1.

FIG. 7 is an exploded view of a second arm of the sealed external tank gauge assembly of FIG. 1.

FIG. 8 is a flow chart for the use of the partial section view of the sealed external tank gauge assembly of FIG. 1.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the assemblies, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The assembly and method in accordance with the present application overcomes one or more of the above-discussed problems commonly associated with traditional security devices for doors. In particular, the assembly is configured to operate with a tank and an external gauge and without continual out-gassing of vapors. The assembly is designed to be enclosed and provide an accurate, cheap, and simple way of measuring the fluid levels inside of tanks. The assembly's enclosed nature eliminates venting of the vapors from the fluid inside the tank into the environment. These and other unique features of the assembly are discussed below and illustrated in the accompanying drawings.

The assembly and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The assembly and method of the present application is illustrated in the associated drawings. The assembly includes a first arm and a second arm extending away from a housing unit. The first arm seals to a tank and the housing unit. The second arm seals to a fluid measuring gauge and the housing unit. Additional features and functions of the assembly are illustrated and discussed below.

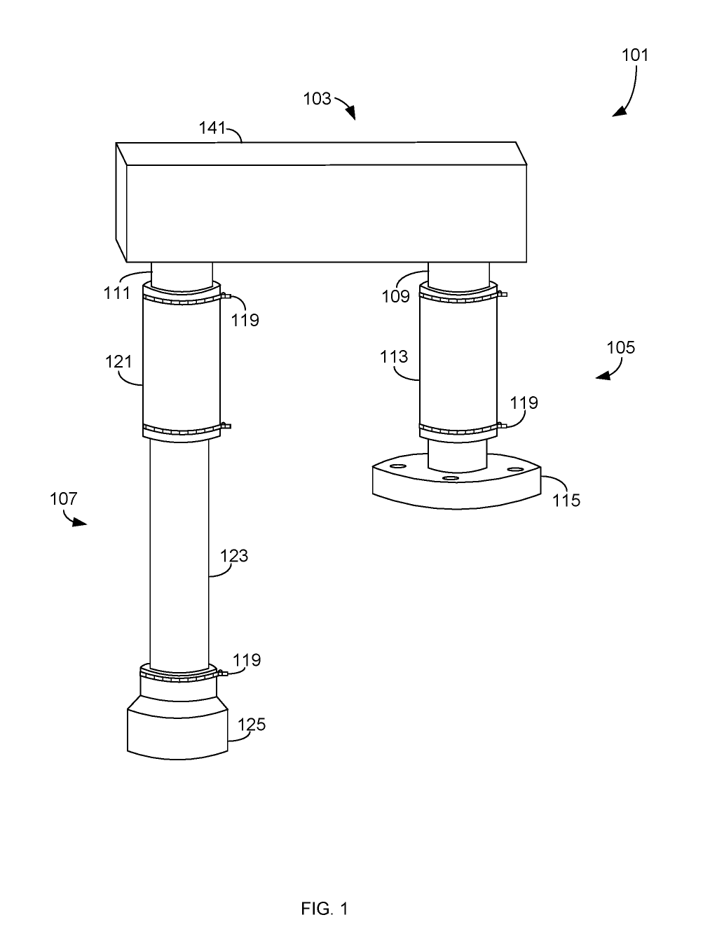

Referring now to the drawings wherein like reference characters identify corresponding or similar elements in form and function throughout the several views. FIG. 1 illustrate a back, perspective view of a sealed external tank gauge assembly 101 of the present application. Assembly 101 comprises a housing unit 103 which is in selective communication with a first arm 105 and a second arm 107. Communication between the housing unit 103 and first arm 105 and second arm 107 are impermeable. It is understood that the impermeable communication is selective and can be obtained through any commonly used method, including a clamp 119 or an interference fit. Assembly 101 is sealed and configured to prohibit the release of vapors between the first arm 105, the housing unit 103, and the second arm 107.

Housing unit 103 has an interior space defined by a plurality of sides. The housing unit 103 has a first port 109 and a second port 111 located at different locations on the housing unit. First port 109 and second port 111 extend away from at least one of the plurality of sides. It is understood that first port 109 can also be configured to extend away from a different side of housing unit 103, or the same side of housing unit 103, as second port 111. First port 109 and second port 111 provide access to the interior space.

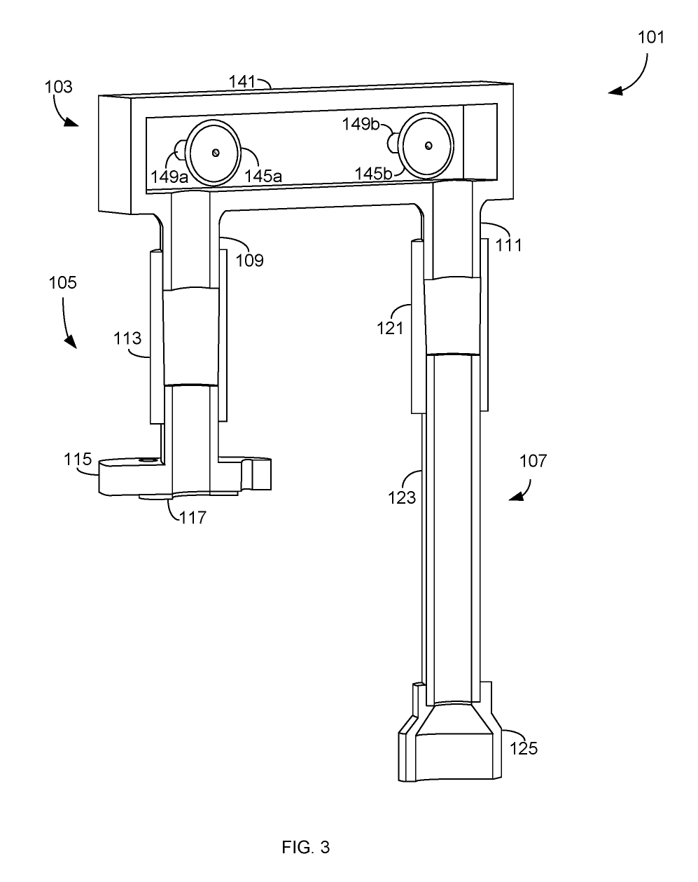

First arm 105 is in selective communication with first port 109 through a first union 113. First arm 105 has a central passageway formed when first union 113 is in selective communication with a flange 115 and flange 115 is in selective communication with a gasket 117 (see FIG. 3). Communication between first union 113 and flange 115 is impermeable. Communication between flange 115 and gasket 117 (see FIG. 3) is impermeable. The central passageway provides access to the interior space of housing unit 103 through first port 109.

Second arm 107 is in selective communication with second port 111 through a second union 121. Second arm 107 has a central passageway formed when second union 121 is in selective communication with one end of a pipe 123 and the other end of pipe 123 is in selective communication with a coupling 125. Communication between second union 121 and pipe 123 is impermeable. Communication between pipe 123 and coupling 125 is impermeable. The central passageway provides access to the interior space of housing unit 103 through second port 111.

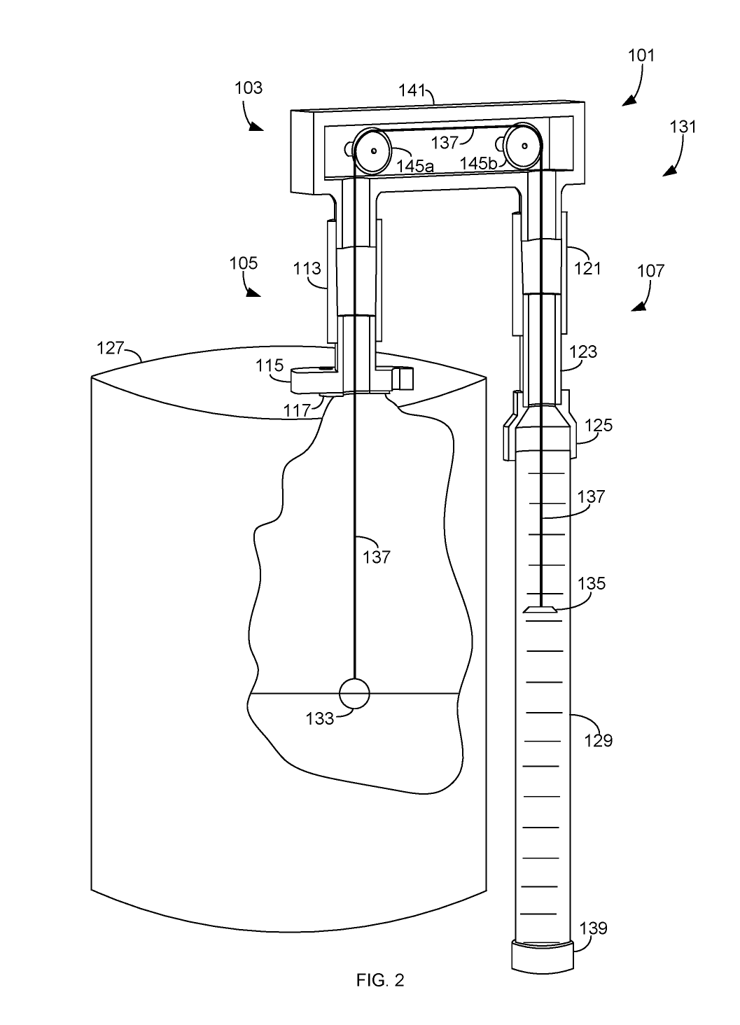

Referring now also to FIGS. 2-3 in the drawings, assorted views of assembly 101 are shown. FIG. 2 illustrates an embodiment of assembly 101 in communication with a tank 127 and an external gauge 129. Both tank 127 and external gauge 129 may be included in assembly 101 as a full measuring system and holding device. Also shown is a fluid measuring system 131 which comprises a fluid level monitor 133, a fluid level indicator 135, and a connecting line 137, each of which may optionally be further included into assembly 101.

Tank 127 is designed to hold a volume of fluid in its interior. Tank 127 is in impermeable communication with gasket 117. Gasket 117 is located between Tank 127 and flange 115. Here, the impermeable communication is a result of an attractive force being exerted between flange 115 and tank 127. This attractive force can be achieved through fastenings, magnetism, or any other commonly used method. It is understood that flange 115, gasket 117, and tank 127 are releasably coupled together.

External gauge 129 is in impermeable communication with coupling 125, at one end. At an opposing end, a portion of external gauge 129 is in impermeable communication with a cap 139. External gauge 129 has markings such that a user is informed of the fluid levels inside of tank 127 without the user opening tank 127. Cap 139 serves to prevent vapors from escaping from assembly 101 and the fluid measuring system 131 through the external gauge 129.

The fluid level monitor 133 is configured to float at or near the surface of the fluid located inside tank 127. Fluid level monitor 133 is denser than the gasses found in tank 127, but less dense than the measured fluid. The fluid level indicator 135 is located in the external gauge 129 and provides a visual representation of the fluid level in the tank 127. External gauge 129 is designed with a preset range of numbers or marks down its length, from coupling 125 to cap 139. It is understood that those marks are related to a value and can be changed depending on what is being measured. The location of fluid level indicator 135 inside external gauge 129 is dependent on the location of fluid level monitor 133 inside tank 127.

Fluid level monitor 133 and fluid level indicator 135 are in physical communication with each other through the connecting line 137. It is understood that the fluid level monitor 133 represents items such as, but not limited to, rope, strap, chain, etc. At one end of connecting line 137, fluid level monitor 133 is attached to connecting line 137 through any method of attachment including a knot, magnetism, or a clasp. Connecting line 137 extends from fluid level monitor, up through the central passageway of the first arm 105, through the interior space of housing unit 103, down through the central passageway of the second arm 107, and into the external gauge 129. At the other end of the connecting line 137, fluid level indicator is attached to connecting line 137 through any method of attachment including a knot, magnetism, or a clasp. As fluid levels inside tank 127 rises and falls, fluid level monitor 133 rises and falls, which puts a force on connecting line 137 and causes fluid level indicator 135 to rise and fall inside external gauge 129. The travel of connecting line 137, through the interior space of housing unit 103, the first arm 105, and second arm 107, is guided by one or more pulleys located in the interior space of housing unit 103.

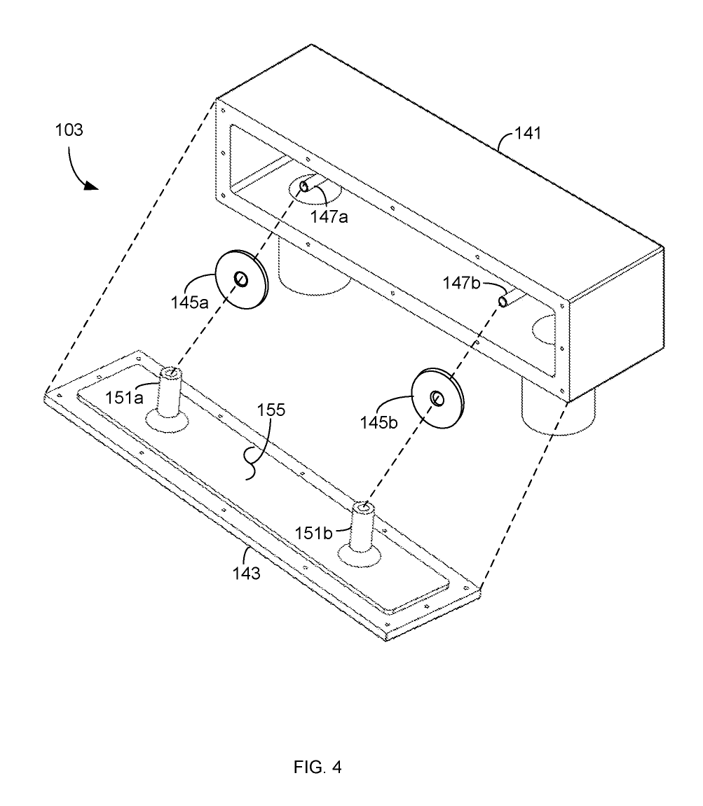

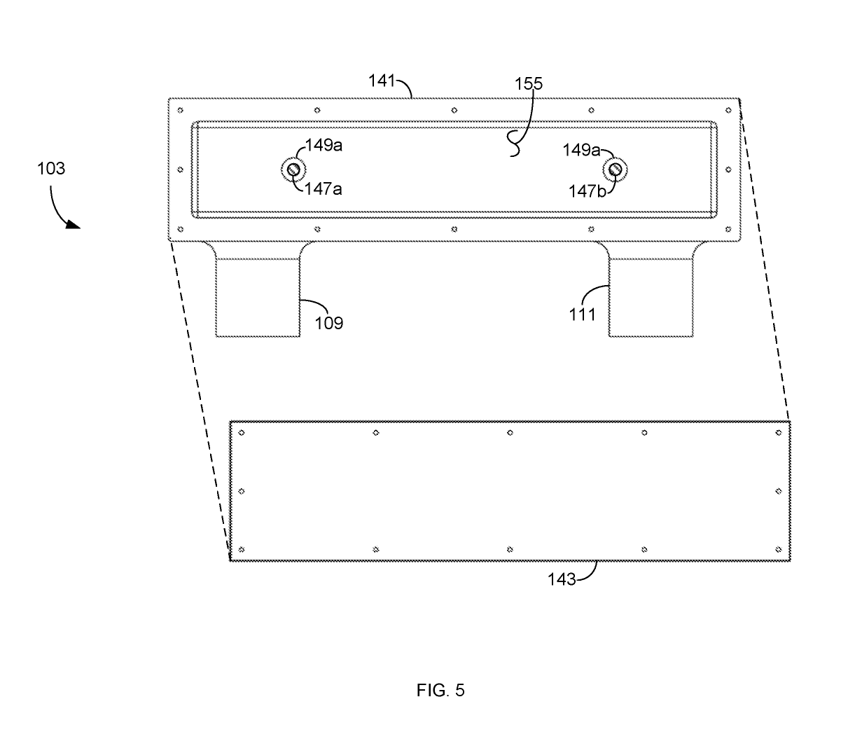

Referring now also to FIGS. 4-5 in the drawings, assorted exploded views of housing unit 103 are shown. Housing unit 103 further includes a housing case 141 and a housing cover 143. Housing case 141 is comprised of a plurality of sides. At least a portion of one or more of the plurality of sides comprises the housing cover 143. Housing cover 143 is in impermeable communication with housing case 141 and is removed to access the interior space of housing unit 103. Housing cover 143 may be attached to housing case 141 through a fastener, such as screws, bolts, magnetism, or any other method available to secure one item to another. It is understood that housing unit 103, in other embodiments, may be configured with a plurality of housing covers 143.

A pair of pulleys are located in the interior space of housing unit 103. A first port pulley 145a is located adjacent to first port 109 and between the first port 109 and second port 111. A second port pulley 145b is adjacent to second port 111 and between the first port 109 and second port 111. First port pulley 145a is similar in form and function to that of second port pulley 145b except as herein noted. Like reference characters identify corresponding or similar elements in form and function between first port pulley 145a and second port pulley 145b. While the current embodiment illustrates the use of two pulleys, first port pulley 145a and second port pulley 145b, it is understood that other embodiments of assembly 101 may have one or more pulleys located in housing unit 103.

First port pulley 145a surrounds and rotates around a portion of a first axle 147a. First axle 147a is supported between two hubs; a first case hub 149a in communication with a case interior surface 153 and a first cover hub 151a in communication with a cover interior surface 155. First cover hub 151a and first case hub 149a are attached to housing cover 143 and housing case 141, respectively, through any method, including magnetism, bonding, etc. First axle 147a is allowed to spin inside first case hub 149a and first cover hub 151a. While one embodiment of a pulley is illustrated, it is understood that first port pulley 145a may only attach to housing case 141 or housing cover 143. First port pulley 145a may have different configurations in other embodiments in order to accomplish the purpose of first port pulley 145a; which is to guide the change in direction of travel of connecting line 137 (see FIG. 2) between first arm 105 and the interior space of housing unit 103.

Second port pulley 145b also surrounds and rotates around a portion of a second axle 147b. Second port pulley 145b and second axle 147b are similar in form and function to the first port pulley 145a and first axle 147a. Like reference characters identify corresponding or similar elements in form and function between first axle 147a and second axle 147b. Second axle 147b is also secured to the housing case 141 and housing cover 143 through similar hubs, a second case hub 149b and a second cover hub 151b, secured in a similar manner to first case hub 149a and first cover hub 151a. The purpose of second port pulley 145b is to guide the change in direction of travel of connecting line 137 (see FIG. 2) between the interior space of housing unit 103 and second arm 107.

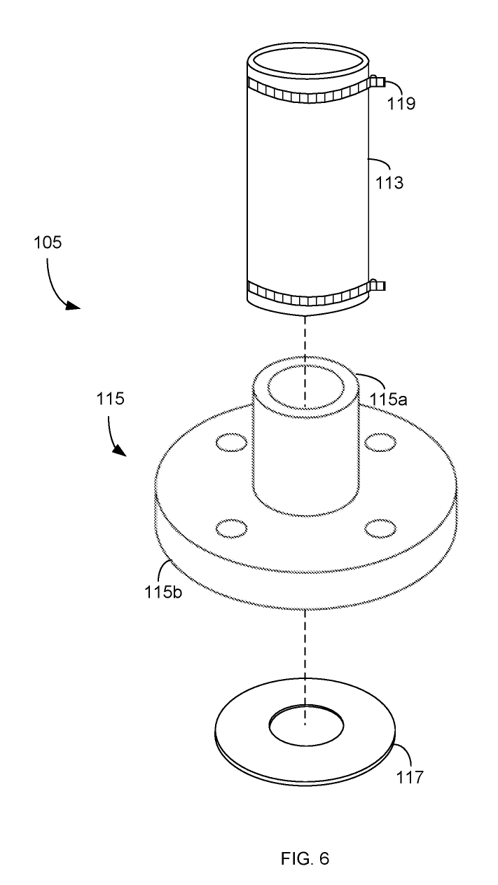

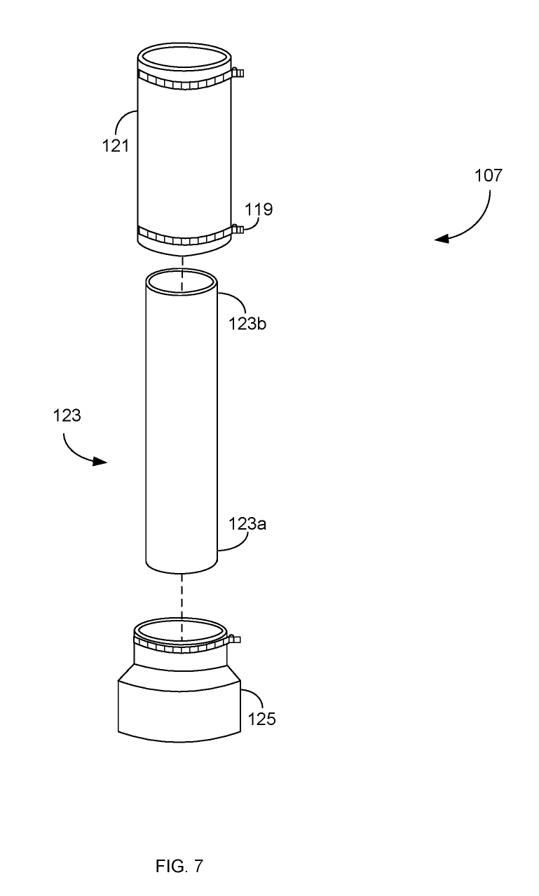

Referring now also to FIGS. 6-7 in the drawings, exploded views of first arm 105 and second arm 107 are shown. The lengths of first arm 105 and second arm 107 are variable to accommodate different sizes of tanks and exterior gauges. Flange 115 has an upper tube 115a which extends upward from a base member 115b which is in communication with gasket 117. The overall length of first arm 105 is adjusted by altering the amount of the selected portions of upper tube 115a and first port 109 which translate into first union 113.

Pipe 123 has an upper pipe 123a at one end and a lower pipe 123b at the opposite end. Lower pipe 123b is in selective communication with coupling 125. The overall length of second arm 107 is adjusted by altering the amount of the selected portions of upper pipe 123a and second port 111 which are translated into second union 121.

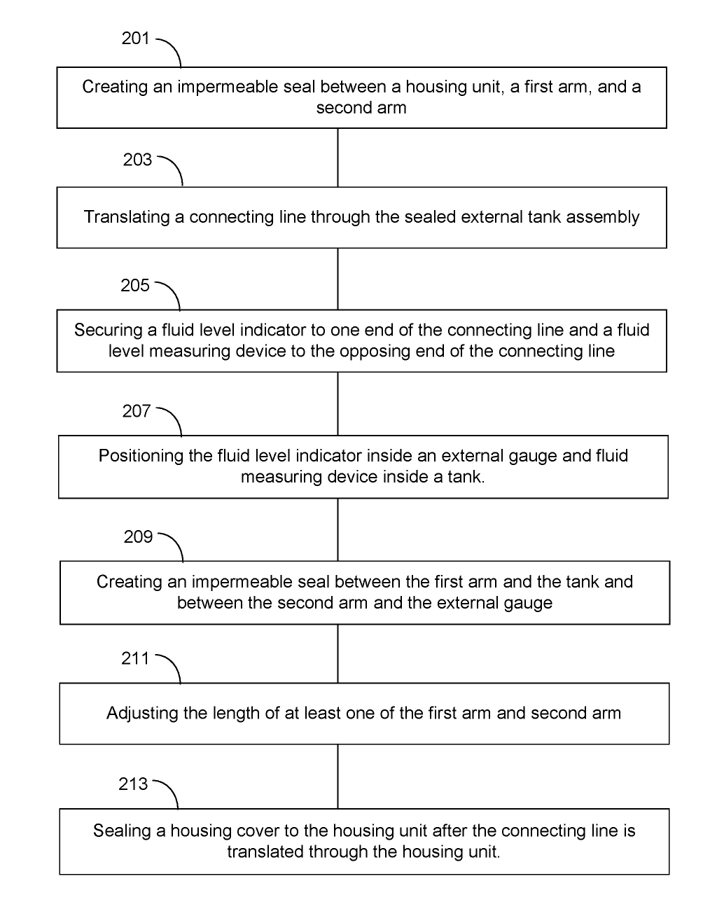

Referring now also to FIG. 8, demonstrating the method for installation of the sealed external tank assembly. The user secures the first arm and the second arm to the housing unit, creating an impermeable seal at the points of attachment, step 201. It is understood that assembling the housing unit (excluding a housing cover for access into the housing unit), first arm, and second arm may be necessary prior to step 201. The user translates the connecting line through the first arm, the housing unit, and the second arm, step 203. The connecting line is placed in communication with any pulleys located within the assembly. It is understood that the use of pulleys within the assembly allows for the connecting line to translate through the system with less friction and wear on the connecting line. Friction increases the wear on the connecting line and may cause the connecting line to snag which could result in an inaccurate reading. The fluid level indicator is secured to one end of the connecting line and the fluid level measuring device is secured to the opposite end of the connecting line, step 205. Position the fluid level indicator inside the external gauge and the fluid measuring device inside the tank, step 207. It is understood that adjustments to the total length of the connecting line may be required. Create an impermeable seal between the first arm and the tank and between the second arm and the external gauge, step 209. It is understood that the seal is selective and the user may detach the assembly from at least one of the tank and external gauge as needed. The user adjusts the length of at least one of the first arm and second arm as needed, step 211. The user creates an impermeable seal between the housing cover and the housing unit, step 213. It is understood that step 211 may occur at any time before, during and after installation and that step 213 may occur at any time after the connecting line is translated through the housing unit.

The current application has many advantages over the prior art including at least the following: (1) The assembly is accurate; (2) It is cheap compared to the more technologically advanced methods to measure fluids in a tank; (3) it is easy to set-up and requires little training; and (4) it is environmentally conscious.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A sealed external tank gauge assembly, comprising:
a housing unit having an interior space defined by a plurality of sides, the housing unit has a first port and a second port located at different locations on the housing unit,
the first port and the second port provide access to the interior space;
a first arm having a first central passageway, the first arm impermeably couples to the first port allowing access to the interior space through the first central passageway, the coupling of the first arm to the first port is resealable;
a second arm having a second central passageway, the second arm impermeably couples to the second port allowing access to the interior space through the second central passageway, the coupling of the second arm to the second port is resealable; and
wherein the sealed external tank gauge assembly is configured to prohibit the release of out gasses between the first arm, housing unit, and the second arm.

2. The assembly of claim 1, wherein the housing unit has a housing cover configured to resealably communicate with a portion of the plurality of sides, the housing cover providing access to the interior space.

3. The assembly of claim 1, wherein the length of the first arm is adjustable, the first arm having a first union, a flange, and a gasket.

4. The assembly of claim 1, further comprising:
a first union extending between the first port and a flange, wherein the first port and the flange selectively translate within the first union, thereby adjusting the length of the first arm.

5. The assembly of claim 1, wherein the length of the second arm is adjustable, the second arm having a second union, a pipe, and a coupling.

6. The assembly of claim 1, further comprising:
a second union extending between the second port and a pipe a, wherein the second port and the pipe selectively translate within the second union, thereby adjusting the length of the second arm.

7. The assembly of claim 1, further comprising:
a fluid measuring system configured to provide an external representation of a fluid level.

8. The assembly of claim 7, wherein the fluid measuring system includes a fluid level monitor and a fluid level indicator, the fluid level monitor detects the fluid level in a tank, the fluid level indicator provides a visual representation of the fluid level in the tank.

9. The assembly of claim 7, further comprising:
a connecting line, extending between a fluid level monitor and a fluid level indicator.

10. The assembly of claim 9, further comprising:
one or more pulleys located within the housing unit to guide the travel of the connecting line through the interior space of the housing unit and the first arm and the second arm.

11. The assembly of claim 10, wherein the pulley surrounds and rotates around a portion of an axle.

12. The assembly of claim 1, wherein the first arm is resealably coupled to a tank, the first arm being sealed against the tank; and the second arm is resealably coupled to an external gauge, the second arm being sealed against the external gauge, a volume of gas within the tank being sealed within the first arm, second arm, the housing unit, and the external gauge.

13. The assembly of claim 1, further comprising:
a cap resealably coupled to the bottom of the external gauge.

14. A method of using a sealed external tank gauge assembly, comprising:
creating an impermeable seal between a housing unit, a first arm, and a second arm;
translating a connecting line through the sealed external tank assembly;
securing a fluid measuring device to one end of the connecting line;
securing a fluid level indicator to an opposing end of the connecting line from the fluid measuring device;
positioning the fluid measuring device in a tank;
positioning the fluid level indicator inside to an external gauge;
creating an impermeable seal between the first arm and the tank; and
creating an impermeable seal between the second arm and the external gauge.

15. The assembly of claim 14, further comprising:
sealing a housing cover to the housing unit after the connecting line is translated through the housing unit.

16. The assembly of claim 14, further comprising:
adjusting the length of at least one of the first arm and second arm.
